(19) United States
(12) Patent Application Publication
(10) Pub. No.: US 2020/0018983 A1
(43) Pub. Date: Jan. 16, 2020

(54) DISPLAY DEVICE

(71) Applicants: FUZHOU BOE OPTOELECTRONICS TECHNOLOGY CO., LTD., Fuzhou (CN); BOE TECHNOLOGY GROUP CO., LTD., Beijing (CN)

(72) Inventors: Zhendian WU, Beijing (CN); Changhong SHI, Beijing (CN); Jin WANG, Beijing (CN); Xi CHEN, Beijing (CN); Yao LIU, Beijing (CN); Zuwen LIU, Beijing (CN); Zongxiang LI, Beijing (CN); Jiamin LIAO, Beijing (CN); Guichun HONG, Beijing (CN); Wenchang TAO, Beijing (CN); Yaochao LV, Beijing (CN); Xinmao QIU, Beijing (CN); Zihua ZHUANG, Beijing (CN); Dahai LI, Beijing (CN); Linlin LIN, Beijing (CN); Min ZHOU, Beijing (CN); Yun BAI, Beijing (CN)

(21) Appl. No.: 16/394,423

(22) Filed: Apr. 25, 2019

(30) Foreign Application Priority Data
Jul. 13, 2018 (CN) 201810772163.X

(51) Int. Cl. G02B 27/22; G02F 1/13; G02F 1/1333; G02F 1/1337

(52) U.S. Cl. CPC G02B 27/2214; G02F 1/1313; G02F 2001/133757; G02F 1/133753; G02F 1/133345

(57) ABSTRACT

A display device is disclosed. The display device includes a display array layer and a liquid crystal control layer superimposed on a display side of the display array layer. The liquid crystal control layer includes a first electrode layer, a liquid crystal layer and a second electrode layer; the display array layer includes first pixels and second pixels alternately arranged in a first direction; and the first electrode layer and the second electrode layer are configured to receive driving voltages, so as to allow liquid crystal molecules in the liquid crystal layer to rotate to form first light deflection regions and second light deflection regions that are alternately arranged in the first direction, so as to form a first view point and a second view point.

### CROSS REFERENCE TO RELATED APPLICATIONS

The application claims priority to Chinese patent application No. 201810772163.X, filed on Jul. 13, 2018, the entire disclosure of which is incorporated herein by reference as part of the present application.

### TECHNICAL FIELD

Embodiments of the present disclosure relate to a display device.

### BACKGROUND

In recent years, three-dimensional (3D) display devices have become a major developing trend in the field of display. The principle of one kind of 3D display devices is that, a person's left eye and right eye respectively receive different images with parallax (for example, a first image and a second image with parallax), and then the brain produces stereoscopic vision (such as distance sense, depth sense, and stereoscopic sense) based on the first image observed by the left eye (a left-eye image) and the second image observed by the right eye (a right-eye image).

Mainstream 3D display devices at present are generally auxiliary 3D display devices, that is, display devices in need of wearing glasses (e.g., anaglyphic glasses, polarization glasses or shutter glasses) or a helmet so as to feed the left-eye image and the right-eye image into the user's left eye and right eye, respectively. However, the discomfort caused by glasses or helmet has prevented the further development of auxiliary 3D display devices and prompted the industry to turn to research and development of naked-eye 3D display devices.

Currently, the naked-eye 3D display devices can be divided into the following four types of display devices according to the technical principle: electronic barrier grating type display devices, display devices with lenticular lens technology, shutter interference backlight type display devices and bilayer display type display devices. Here, electronic barrier grating technology is also known as parallax barrier technology or parallax barrier grating technology.

### SUMMARY

At least one embodiment of the present disclosure provides a display device. The display device comprises a display array layer and a liquid crystal control layer superimposed on a display side of the display array layer. The liquid crystal control layer comprises a first electrode layer, a liquid crystal layer and a second electrode layer, the display array layer comprises first pixels and second pixels which are alternately arranged in a first direction; the first electrode layer and the second electrode layer are configured to receive driving voltages, so as to allow liquid crystal molecules in the liquid crystal layer to rotate to form first light deflection regions and second light deflection regions that are alternately arranged in the first direction; the first light deflection regions respectively correspond to the first pixels and the second light deflection regions respectively correspond to the second pixels; and light that is emitted from the first pixels and enters the first light deflection regions is deflected to form a first view point, and light that is emitted from the second pixels and enters the second light deflection regions is deflected to form a second view point.

For example, in at least one example of the display device, the liquid crystal molecules are ionic liquid crystals.

For example, in at least one example of the display device, widths of the first light deflection regions in the first direction are respectively equal to widths of corresponding first pixels in the first direction; and widths of the second light deflection regions in the first direction are respectively equal to widths of corresponding second pixels in the first direction.

For example, in at least one example of the display device, the first electrode layer comprises first sub-electrodes respectively located in the first light deflection regions and second sub-electrodes respectively located in the second light deflection regions.

For example, in at least one example of the display device, the liquid crystal control layer further comprises a first alignment layer and a second alignment layer; the first alignment layer is disposed on a side, which is closer to the liquid crystal layer, of the first electrode layer, the second alignment layer is disposed on a side, which is closer to the liquid crystal layer, of the second electrode layer; and the first alignment layer and the second alignment layer are configured to allow liquid crystal molecules located in the first light deflection regions to be capable of rotating toward a first rotation direction and to allow liquid crystal molecules located in the second light deflection regions to be capable of rotating toward a second rotation direction that is opposite to the first rotation direction.

For example, in at least one example of the display device, the first alignment layer and the second alignment layer are further configured to allow liquid crystal molecules located in one of the first light deflection regions and one of the second light deflection regions that are adjacent to each other to be arranged symmetrically with respect to an abutted face of the one of first light deflection regions and the one of second light deflection regions that are adjacent to each other.

For example, in at least one example of the display device, an alignment direction of the first alignment layer corresponding to the first light deflection regions is same as an alignment direction of the first alignment layer corresponding to the second light deflection regions; an alignment direction of the second alignment layer corresponding to the first light deflection regions is same as an alignment direction of the second alignment layer corresponding to the second light deflection regions; and the alignment direction of the first alignment layer corresponding to the first light deflection regions is opposite to the alignment direction of the second alignment layer corresponding to the first light deflection regions.

For example, in at least one example of the display device, the display device further comprises a drive device that is electrically connected to the first sub-electrodes and the second sub-electrodes and is configured to apply the driving voltages to the first sub-electrodes and the second sub-electrodes; the drive device is configured to apply a first voltage to the first sub-electrodes, apply a second voltage to the second sub-electrodes, and to apply an opposite voltage to the second electrode layer; the first voltage, the second voltage and the opposite voltage are functioning as the driving voltages; and the first voltage is greater than the opposite voltage, and the second voltage is smaller than the opposite voltage.

For example, in at least one example of the display device, an absolute value of a difference between the first voltage and the opposite voltage is equal to an absolute value of a difference between the second voltage and the opposite voltage.

For example, in at least one example of the display device, the first alignment layer comprises first alignment units respectively located in corresponding first light deflection regions and second alignment units respectively located in corresponding second light deflection regions, an alignment direction of the first alignment units and an alignment direction of the second alignment units are opposite; and the second alignment layer comprises third alignment units respectively positioned in corresponding first light deflection regions and fourth alignment units respectively positioned in corresponding second light deflection regions, an alignment direction of the third alignment units and an alignment direction of the fourth alignment units are opposite.

For example, in at least one example of the display device, the alignment direction of the third alignment units is same as the alignment direction of the second alignment units; and the alignment direction of the fourth alignment units is same as the alignment direction of the first alignment units.

For example, in at least one example of the display device, the display device further comprises a drive device that is electrically connected to the first sub-electrodes and the second sub-electrodes and is configured to apply the driving voltages to the first sub-electrodes and the second sub-electrodes; and the drive device is configured to apply same one voltage to the first sub-electrodes and the second sub-electrodes.

For example, in at least one example of the display device, the display device further comprises a first substrate, a second substrate, an insulating layer and a sealant. The first substrate and the second substrate are configured to interpose the display array layer and the liquid crystal control layer that are stacked with each other between the first substrate and the second substrate; the insulating layer is disposed between the display array layer and the first electrode layer; and the sealant is disposed in a peripheral area of the display device and is used to combine together the first substrate with the second substrate.

For example, in at least one example of the display device, the first pixel and the second pixel respectively comprise a self-luminous component.

For example, in at least one example of the display device, the display device further comprises an eyeball tracking sensor. The display device is configured to adjust the driving voltages applied to the first electrode layer and the second electrode layer based on an output of the eyeball tracking sensor.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a parallax grating type 3D display device;

FIG. 2A is a schematically sectional view illustrating a display device provided by at least one embodiment of the present disclosure;

FIG. 2B is a schematically sectional view illustrating a liquid crystal control layer provided by at least one embodiment of the present disclosure;

FIG. 3A is a schematic plan view illustrating a first electrode layer provided by at least one embodiment of the present disclosure;

FIG. 3B is a schematically sectional view illustrating another first electrode layer provided by at least one embodiment of the present disclosure;

FIG. 4A is a schematic plan view illustrating a first alignment layer provided by at least one embodiment of the present disclosure;

FIG. 4B is a schematic plan view illustrating a second alignment layer provided by at least one embodiment of the present disclosure;

FIG. 5A is a schematic diagram illustrating arrangement of liquid crystal molecules after a voltage is applied to the liquid crystal molecules, provided by at least one embodiment of the present disclosure;

FIG. 5B is a schematic diagram illustrating rotation of liquid crystal molecules in a first light deflection region, provided by at least one embodiment of the present disclosure;

FIG. 5C is a schematic diagram illustrating rotation of liquid crystal molecules in a second light deflection region, provided by at least one embodiment of the present disclosure;

FIG. 6 is a schematic diagram illustrating respective incidence of the light from a first pixel and of the light from a second pixel into the left eye and right eye of a user under the action of a liquid crystal control layer, provided by at least one embodiment of the present disclosure;

FIG. 7A is a schematic diagram illustrating another liquid crystal control layer provided by at least one embodiment of the present disclosure;

FIG. 7B is a schematic plan view illustrating another first alignment layer provided by at least one embodiment of the present disclosure;

FIG. 7C is a schematic plan view illustrating another second alignment layer provided by at least one embodiment of the present disclosure;

FIG. 8 is a schematic diagram illustrating control of light emitted by a display array layer by a liquid crystal control layer provided by one embodiment of the present disclosure;

FIG. 9 is another schematic diagram illustrating control of light emitted by a display array layer by a liquid crystal control layer provided by one embodiment of the present disclosure; and

FIG. 10 is a schematic flowchart illustrating adjustment of formation position of a first view point and a second view point, provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

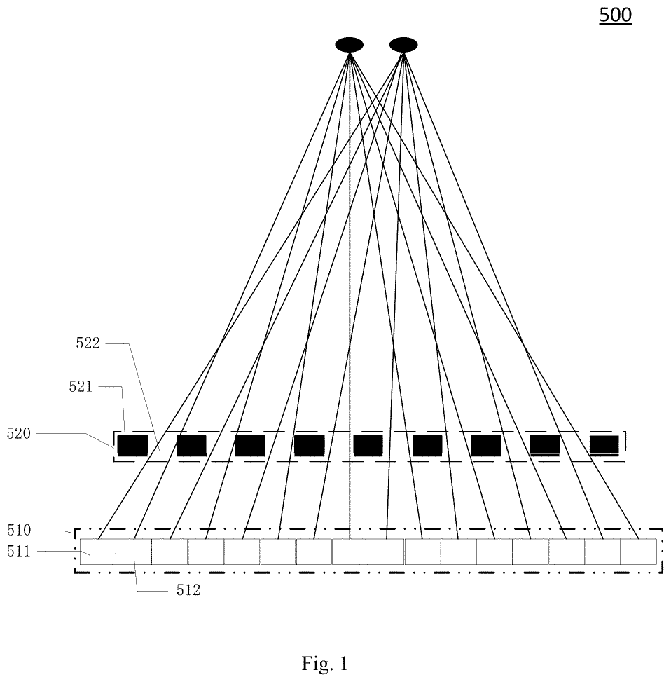

FIG. 1 is a parallax grating type 3D display device 500. As illustrated in FIG. 1, the parallax grating type 3D display device 500 includes a liquid crystal display panel 510 and a parallax grating 520. The parallax grating 520 includes light-shielding regions 521 and light-transmissive regions 522 alternately arranged in the horizontal direction. The liquid crystal display panel 510 includes left-eye pixels 511 and right-eye pixels 512 alternately arranged in the horizontal direction, so as to emit light corresponding to a left-eye image and light corresponding to a right-eye image, respectively. Here, each of the left-eye pixels 511 and each of the right-eye pixels 512 may include one thin film transistor (TFT) as a switching element.

As illustrated in FIG. 1, when the parallax grating 520 is correctly attached with the liquid crystal display panel 510, under the shielding of the parallax grating 520, the light emitted from the left-eye pixels 511 and the light emitted from the right-eye pixels 512 can be incident into a user's left eye and right eye, respectively. Thereby, the user's brain can produce stereoscopic vision based on a left-eye image observed by the left eye and a right-eye image observed by the right eye (that is, see an image with 3D visual effect).

When an ordinary parallax barrier type display device is used for displaying a two-dimensional (2D) image, left-eye pixels 511 and right-eye pixels 512 are used for display of the same image pixels (for example, light emitted by one of the left-eye pixels 511 and light emitted by one of the right-eye pixels 512 combine with each other to form one of the image pixels). Thereby, as compared with the case of displaying a 2D image with use of the liquid crystal display panel 510 directly, the transverse or longitudinal resolution of the 2D image displayed by using the parallax barrier type display device is halved.

The parallax grating 520 may be implemented with a liquid crystal cell, which includes a first polarizer, a first substrate, a grating electrode, a liquid crystal layer, a counter electrode, a second substrate and a second polarizer. The grating electrode includes a plurality of electrode strips arranged in the horizontal direction, and a gap is arranged between adjacent electrode strips. Liquid crystal molecules of the liquid crystal layer corresponding to the electrode strips rotate when they are driven by a voltage applied to the electrode strips, and thus the light-shielding regions 521 of the parallax grating 520 are formed; liquid crystal molecules of the liquid crystal layer corresponding to the gap between adjacent electrode strips do not rotate, and thus the light-transmissive regions 522 of the parallax grating 520 are formed.

As noticed by inventors of the present disclosure, in the case where a liquid crystal cell is adopted as the parallax grating 520 of the 3D display device 500, because the width of an electrode strip in the horizontal direction and the width of a gap in the horizontal direction are fixed values, once there is a deviation between the grating electrode and the liquid crystal panel including thin film transistors upon attachment (for example, there is a deviation in the horizontal direction), the deviation can lead to deterioration of 3D display effect of the parallax grating type 3D display device 500, the deviation can even cause the 3D display function to be unable to be realized. Furthermore, owing to the fact that, after attachment of the parallax grating 520 with the liquid crystal display panel 510 including thin film transistors is completed, it is difficult to separate the parallax grating 520 from the liquid crystal display panel 510 and attach them once again, and therefore, the yield of the parallax grating type 3D display device 500 is relatively low.

Secondly, the inventors of the present disclosure also notice that, part of light emitted from the liquid crystal display panel 510 is shielded by the light-shielding regions 521 of the parallax barrier, and thus display brightness of the parallax barrier type 3D display device 500 is reduced (in case that power consumption remains unchanged).

In addition, the inventors of the present disclosure further notice that, a liquid crystal cell is attached onto the liquid crystal panel in the parallax grating type 3D display device 500, and the liquid crystal cell further includes a first polarizer. Therefore, the thickness and weight of the parallax grating type 3D display device 500 are relatively large, and this is contrary to consumers' expectations that the 3D display device 500 will be lighter and thinner.

At least one embodiment of the present disclosure provides a display device. The display device comprises a display array layer and a liquid crystal control layer superimposed on a display side of the display array layer. The liquid crystal control layer comprises a first electrode layer, a liquid crystal layer and a second electrode layer; the display array layer comprises first pixels and second pixels which are alternately arranged in a first direction; the first electrode layer and the second electrode layer are configured to receive driving voltages, so as to allow liquid crystal molecules in the liquid crystal layer to rotate to form first light deflection regions and second light deflection regions that are alternately arranged in the first direction; the first light deflection regions respectively correspond to the first pixels and the second light deflection regions respectively correspond to the second pixels; and light that is emitted from the first pixels and enters the first light deflection regions is deflected to form a first view point, and light that is emitted from the second pixels and enters the second light deflection regions is deflected to form a second view point.

In at least one embodiment of the present disclosure, the first and second pixels of the display array layer respectively emit light corresponding to pixels of a first image (e.g., a left-eye image) and light corresponding to pixels of a second image (e.g., a right-eye image). The light corresponding to the pixels of the first image and the light corresponding to the pixels of the second image are incident into the liquid crystal control layer, and under the action (e. g. under the deflective action) of the liquid crystal control layer, the light corresponding to the pixels of the first image and the light corresponding to the pixels of the second image are incident into a user's left and right eyes, respectively. The user's brain produces stereoscopic vision based on the first image observed by the left eye and the second image observed by the right eye. Consequently, naked-eye 3D display is realized by the display device provided by an embodiment of the present disclosure.

Non-limitive descriptions are given to the display device provided by the embodiments of the present disclosure in the following with reference to a plurality of examples. As described in the following, in case of no conflict, different features in these specific examples may be combined so as to obtain new examples, and the new examples are also fall within the scope of present disclosure.

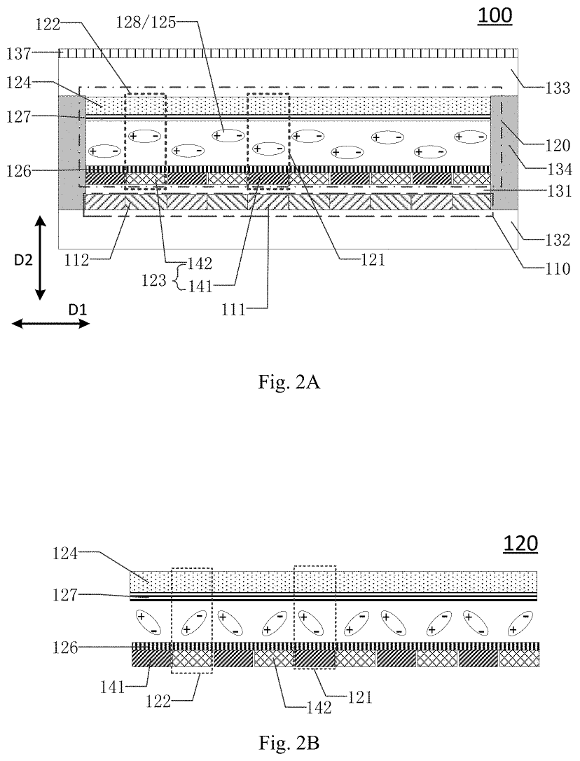

FIG. 2A is a schematically sectional view illustrating a display device 100 provided by at least one embodiment of the present disclosure. As illustrated in FIG. 2A, the display device 100 includes a display array layer 110, and a liquid crystal control layer 120 superimposed on the display side of the display array layer 110.

As illustrated in FIG. 2A, the display array layer 110 includes first pixels 111 and second pixels 112 alternately arranged in a first direction D1 (e. g., horizontal direction). The first pixels 111 are used for display of pixels of a first image, and thus the first image is obtained by combination of the pixels of the first image (for example, the first image is formed by combination of the pixels, which are displayed by all the first pixels 111, of the first image); the second pixels 112 are used for display of pixels of a second image, and thus the second image is obtained by combination of the pixels of the second image (for example, the second image is formed by combination of the pixels, which are displayed by all the second pixels 112, of the second image). That is, the first pixels 111 and the second pixels 112 respectively emit the light corresponding to the pixels of the first image and the light corresponding to the pixels of the second image. The first image and the second image are different (have parallax), so as to form a 3D image.

As illustrated in FIG. 2A, the liquid crystal control layer 120 includes a first electrode layer 123, a second electrode layer 124, and a liquid crystal layer 125 interposed between the first electrode layer 123 and the second electrode layer 124. The liquid crystal control layer 120 further includes a first alignment layer 126 and a second alignment layer 127. The first alignment layer 126 is disposed on the side, which is closer to the liquid crystal layer 125, of the first electrode layer 123 (e.g., between the first electrode layer 123 and the liquid crystal layer 125 in a second direction D2), and the second alignment layer 127 is disposed on the side, which is closer to the liquid crystal layer 125, of the second electrode layer 124 (e. g., between the second electrode layer 124 and the liquid crystal layer 125 in the second direction D2). In this case, the first electrode layer 123, the first alignment layer 126, the liquid crystal layer 125, the second alignment layer 127 and the second electrode layer 124 are arranged sequentially (e. g. in the second direction D2).

As illustrated in FIG. 2A, the liquid crystal layer 125 includes a plurality of liquid crystal molecules 128. The liquid crystal molecules 128, for example, are ionic liquid crystals. One end of each of the liquid crystal molecules 128 along the long axis of the each of the liquid crystal molecules 128 shows electropositivity, and the other end of the each of the liquid crystal molecules 128 along the long axis shows electronegativity. Thereby, the each of the liquid crystal molecules 128 can be rotated under the action of the driving voltages applied on the liquid crystal molecules 128 (for example, they are rotated within a plane parallel to the first direction D1 and the second direction D2, namely, within the paper surface of FIG. 2A).

For example, the liquid crystal molecules 128 may be positive liquid crystals, and because the rotational viscosity coefficient of the positive liquid crystals is smaller as compared to the rotational viscosity coefficient of negative liquid crystals, the response time of liquid crystal molecules 128 can be reduced. As illustrated in FIGS. 5B and 5C, the positive liquid crystal molecules 128 rotate toward the direction of making the long axes of liquid crystal molecules 128 parallel to electric lines of force, under the action of an externally applied electric field.

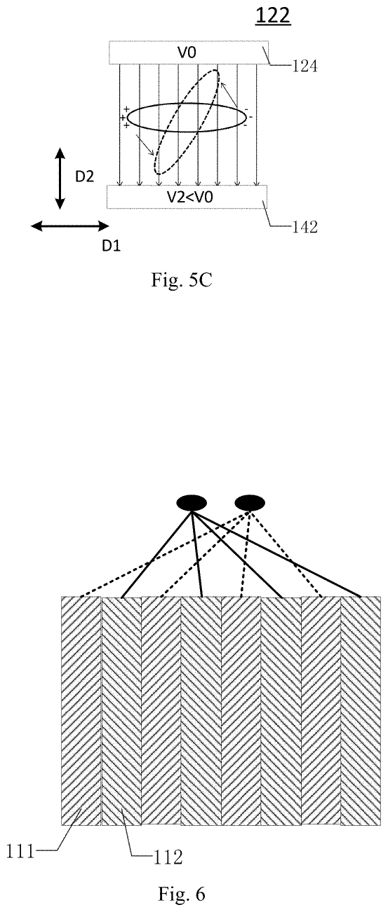

As illustrated in FIG. 2B, FIG. 5A and FIG. 6, the first electrode layer 123 and the second electrode layer 124 may be applied with driving voltages; and this allows the liquid crystal molecules 128 in the liquid crystal layer 125 to be rotated so as to form first light deflection regions 121 and second light deflection regions 122 that are alternately arranged in the first direction D1 and are respectively correspond to the first pixels 111 and the second pixels 112. In such a way, the light that are emitted from the first pixels 111 and the second pixels 112 and enter the first light deflection regions 121 and the second light deflection regions 122 are made to be deflected, so as to form a first view point and a second view point, respectively. In the case where the user's left eye and right eye locate at the first view point and the second view point, respectively, the user's left eye and right eye can observe a first image (e.g., a left-eye image) and a second image (e.g., a right-eye image), respectively, and thus an image with 3D effect can be observed by the user.

Because the first light deflection regions 121 and the second light deflection regions 122 of the display device 100 provided by an embodiment of the present disclosure each permit light incident thereon to pass through, the transmittance of the display device 100 adopting the liquid crystal control layer 120 is relatively higher as compared to a 3D display device employing a parallax barrier, and the brightness of the display device 100 is improved thereby. Therefore, it is possible to lower the power consumption of the display device 100 and to promote the user's experience.

For the display device 100 as illustrated in FIG. 2A, the long axes of the liquid crystal molecules 128 are parallel to the first electrode layer 123 and the second electrode layer 124 in the case where no driving voltage is received by the first electrode layer 123 and the second electrode layer 124, the liquid crystal control layer 120 allows the light which is incident on the liquid crystal control layer 120 to pass through normally, namely, the display device 100 as illustrated in FIG. 2A is in a 2D display mode. In this case, any one of the user's eyes can observe the light emitted by the first pixels 111 and the second pixels 112, and thus, the user can observe an ordinary two-dimensional (2D) image. In this case, because different image pixels can be presented by one of the first pixels 111 and one of the second pixels 112 adjacent to the one of the first pixels 111, the resolution of the 2D image displayed by using the display device provided by an embodiment of the present disclosure is equal to the resolution of a 2D image displayed with the display array layer provided by an embodiment of the present disclosure. Consequently, the user's experience can be promoted.

In addition, compared to the parallax barrier type 3D display device as illustrated in FIG. 1, because the liquid crystal control layer 120 can allow the light emitted by the first pixels 111 and the second pixels 112 to be incident into the user's left and right eyes, respectively, without provision of a first polarizer and a second polarizer, the thickness of the display device 100 can be reduced, and the display brightness of the display device 100 in a 2D display mode can be enhanced. Therefore, the user's experience can be promoted.

As illustrated in FIG. 2A, the widths of the first light deflection regions 121 in the first direction D1 are respectively equal to the widths of corresponding first pixels 111 in the first direction D1, and the widths of the second light deflection regions 122 in the first direction D1 are respectively equal to the widths of corresponding second pixels 112 in the first direction D1, and thus, the liquid crystal molecules in the first light deflection regions 121 and the second light deflection regions 122 can be controlled with better effect. Therefore, the display effect can be improved.

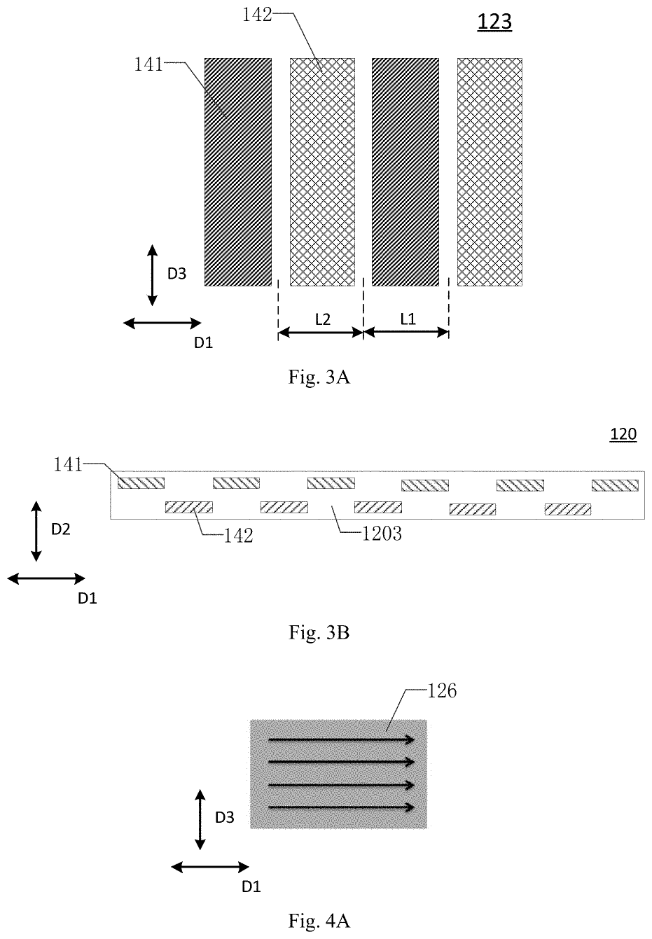

As illustrated in FIG. 2A and FIG. 3A, the second electrode layer 124 is a plate-shape electrode, and the first electrode layer 123 includes first sub-electrodes 141 respectively located in corresponding first light deflection regions 121 and second sub-electrodes 142 respectively located in corresponding second light deflection regions 122. The first sub-electrodes 141 and the second sub-electrodes 142 are alternately arranged in the first direction D1 and respectively extend in a third direction D3. In this case, the first electrode layer 123 is implemented as an electrode layer with a grating-type structure. The first electrode layer 123 and the second electrode layer 124 may, for example, be formed using a transparent conductive material. For example, the transparent conductive material is indium tin oxide (ITO), indium zinc oxide (IZO) or the like.

It is to be noted that, the first direction D1 in an embodiment of the present disclosure may be a horizontal direction, the third direction D3 may be a vertical direction perpendicular to the horizontal direction, and the second direction D2 may be the direction perpendicular to the first direction D1 and the third direction D3. However, embodiments of the present disclosure are not limited to this case.

As illustrated in FIG. 3A, there is a gap between adjacent first and second sub-electrodes 141 and 142 so as to avoid electrical contact between the adjacent first and second sub-electrodes 141 and 142. For example, in the case where a black matrix (not illustrated in the figure) is disposed corresponding to an abutted face of adjacent first and second pixels 111 and 112, the gap between the adjacent first and second sub-electrodes 141 and 142 may correspond to the black matrix, and the width of the gap in the first direction D1 is equal to or smaller than the width of the black matrix in the first direction D1. Thereby, such a case that, the light emitted from the first pixel 111 and the second pixel 112 which are corresponding to the gap cannot be correctly assigned to the correct eye, can be avoided, and thus crosstalk of the display device 100 can be reduced.

As illustrated in FIG. 3A, the spacing L1 between symmetric axes of gaps, which are extending in the third direction and located at two sides of one of the first sub-electrodes 141, is equal to the width of the first pixels 111 in the first direction D1 and the width of the first light deflection regions 121 in the first direction D1; and the spacing L2 between symmetric axes of gaps, which are extending in a third direction and located at two sides of one of the second sub-electrodes 142, is equal to the width of the second pixels 112 in the first direction D1 and the width of the second light deflection regions 122 in the first direction D1. In this case, the rotation direction of the liquid crystal molecules 128 corresponding to each of the first pixels 111 and each of the second pixels 112 can be controlled with better effect. As a result, the light emitted from the first pixels 111 and the light emitted from the second pixels 112 can be made to be incident into the user's left eye and right eye, respectively, and thus crosstalk of the display device 100 can be reduced. In the case where L1 is equal to L2, the width of the first pixels 111 in the first direction D1 is equal to the width of the second pixels 112 in the first direction D1, and the width of the first light deflection regions 121 in the first direction D1 is equal to the width of the second light deflection regions 122 in the first direction D1.

It is to be noted that, the structure of the first electrode layer 123 is not limited to the structure as illustrated in FIG. 2A and FIG. 3A, and according to practical application requirements, the structure of the first electrode layer 123 may also be realized as the structure as illustrated in FIG. 3B. As illustrated in FIG. 3B, a plurality of first sub-electrodes 141 and a plurality of second sub-electrodes 142 are spaced apart in the second direction D2, and a portion of an insulating medium 1203 is arranged between the plane in which the plurality of first sub-electrodes 141 locate and the plane in which the plurality of second sub-electrodes 142 locate, so that the first sub-electrodes 141 and the second sub-electrodes 142 are electrically insulated from each other; for example, other portion of the insulating medium 1203 is arranged at the side, which is away from the plane in which the plurality of second sub-electrodes 142 locate, of the plane in which the plurality of first sub-electrodes 141 locate, and is arranged at the side, which is away from the plane in which the plurality of first sub-electrodes 141 locate, of the plane in which the plurality of second sub-electrodes 142 locate, that is, both the plane in which the plurality of first sub-electrodes 141 locate and the plane in which the plurality of second sub-electrodes 142 locate are provided in the insulating medium 1203. In this case, the first electrode layer 123 can contact the display array layer 110 directly. For example, as illustrated in FIG. 3B, the orthographic projection of one of the second sub-electrodes 142 on the plane in which the first sub-electrodes 141 locate contacts adjacent first sub-electrodes 141 while the orthographic projection of the one of the second sub-electrodes 142 on the plane in which the first sub-electrodes 141 locate and adjacent first sub-electrodes 141 does not overlapped with each other, so that the capacity of the first electrode layer 123 and the second electrode layer 124 to control the liquid crystal layer 125 can be enhanced, and thus, crosstalk of the display device 100 can be reduced. Therefore, 3D display effect of the display device 100 can be promoted.

It is to be noted that, according to the actual application requirements, the first electrode layer 123 may be implemented as a plate-shape electrode, while the second electrode layer 124 may be implemented as the structure as illustrated in FIG. 3A or FIG. 3B, or alternatively, both the first electrode layer 123 and the second electrode layer 124 may be implemented as the structure as illustrated in FIG. 3A or FIG. 3B, details being omitted here.

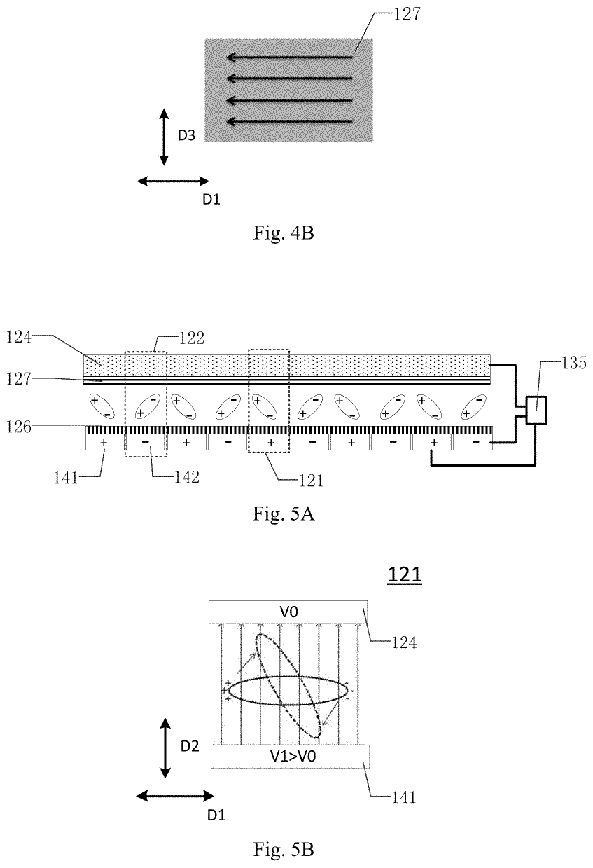

As illustrated in FIG. 2B, the first alignment layer 126 and the second alignment layer 127 are configured to allow the liquid crystal molecules 128 located in the first light deflection regions 121 to rotate toward a first rotation direction, and to allow the liquid crystal molecules 128 located in the second light deflection regions 122 to rotate toward a second rotation direction that is opposite to the first rotation direction, that is, the first alignment layer 126 and the second alignment layer 127 are configured to allow the liquid crystal molecules 128 located in the first light deflection regions 121 and the liquid crystal molecules 128 located in the second light deflection region 122 to rotate toward opposite directions (for example, under the joint action of the first alignment layer 126 and the second alignment layer 127 as well as the voltages applied onto the first electrode layer 123 and the second electrode layer 124), and thus naked-eye 3D display can be realized by the display device 100. Specific descriptions will be given below in conjunction with FIG. 4A to FIG. 4B and FIG. 5A to FIG. 5C.

As illustrated in FIG. 4A and FIG. 4B, both the alignment direction of the first alignment layer 126 and the alignment direction of the second alignment layer 127 are in the first direction D1 (that is, the direction along the long side in FIG. 4A and FIG. 4B), but the alignment direction of the first alignment layer 126 is opposite to the alignment direction of the second alignment layer 127. In this case, the alignment direction of the first alignment layer 126 corresponding to the first light deflection regions 121 is the same as that of the first alignment layer 126 corresponding to the second light deflection regions 122, the alignment direction of the second alignment layer 127 corresponding to the first light deflection regions 121 is the same as that of the second alignment layer 127 corresponding to the second light deflection regions 122, and the alignment direction of the first alignment layer 126 corresponding to the first light deflection regions 121 is opposite to the alignment direction of the second alignment layer 127 corresponding to the first light deflection regions 121.

The manufacturing method of the first alignment layer 126 and the second alignment layer 127 may be set according to the actual application requirements, and embodiments of the present disclosure do not make specific restrictions on this. For example, a layer of polyimide may be firstly coated on the first electrode layer 123 and the second electrode layer 124, respectively, and then, the polyimide film is rubbed in a predetermined direction with a brush or the like and thus fine grooves along the rubbing direction are formed on a surface of the polyimide film, thereby forming the first alignment layer 126 and the second alignment layer 127. In this case, the alignment directions of the first alignment layer 126 and the second alignment layer 127 are along the rubbing direction. For another example, the first alignment layer 126 and the second alignment layer 127 may also be formed by using a light-control orientation technology, that is, a light-control orientation technology is employed to give surfaces of the first alignment layer 126 and the second alignment layer 127 an alignment effect along a predetermined direction. In this case, the first alignment layer 126 and the second alignment layer 127 are also referred to as optical alignment films.

As illustrated in FIG. 5A, the display device 100 further includes a drive device 135 that is electrically connected to the first sub-electrodes 141 and the second sub-electrodes 142 and is configured to apply a driving voltage to the first sub-electrodes 141 and the second sub-electrodes 142; and the drive device 135 is configured to apply a first voltage V1, a second voltage V2 and an opposite voltage V0 onto the first sub-electrodes 141, the second sub-electrodes 142 and the second electrode layer 124, respectively. According to the practical application requirements, the drive device 135 may also be configured to drive the display array layer 110.

For example, the drive device 135 may include a dedicated hardware device, or one circuit board or combination of multiple circuit boards. The dedicated hardware device may include PLC (Programmable Logic Controller), FPGA (Field Programmable Gate Array), ASIC (Application Specific Integrated Circuit), DSP (Digital Signal Processing device) or other programmable logic control devices. The one circuit board or combination of multiple circuit boards may include at least one of the following devices: (1) one or more processors; (2) one or more non-temporary, computer-readable memories connected to the processor, (3) firmwares stored in memory.

As illustrated in FIG. 5B and FIG. 5C, for allowing the display device to be in a 3D display mode, the first voltage is allowed to be greater than the opposite voltage and the second voltage is allowed to be less than the opposite voltage. In this case, the voltage of the first sub-electrodes 141 relative to the second electrode layer 124 is a positive voltage, and voltage of the second sub-electrodes 142 relative to the second electrode layer 124 is a negative voltage. Therefore, the liquid crystal molecules 128 located in the first light deflection regions rotate clockwise (the first rotation direction), and the liquid crystal molecules 128 located in the second light deflection regions rotate counterclockwise (the second rotation direction), that is, the liquid crystal molecules 128 of the first light deflection regions 121 and the liquid crystal molecules 128 located in the second light deflection regions 122 rotate toward opposite directions.

The angle of rotation of the liquid crystal molecules 128 depends on the value of the voltage applied to the liquid crystal molecules 128. For example, when the absolute value of the difference between the first voltage and the opposite voltage increases, the angle of rotation of the liquid crystal molecules 128 located in the first light deflection regions increases at first and then remains unchanged; when the absolute value of the difference between the second voltage and the opposite voltage increases, the angle of rotation of the liquid crystal molecules 128 located in the second light deflection regions increases at first and then remains unchanged.

As illustrated in FIG. 2B, the first alignment layer 126 and the second alignment layer 127 are further configured to allow the liquid crystal molecules 128 located in one of the first light deflection regions 121 and one of the second light deflection regions 122 that are adjacent to each other to be arranged symmetrically with respect to an abutted face of the one of the first light deflection regions 121 and the one of the second light deflection regions 122 that are adjacent to each other, and thus, 3D display effect of the display device 100 can be enhanced. Therefore, the user's experience can be promoted. It should be noted that, the abutted face of the one of the first light deflection regions and the one of the second light deflection regions adjacent to each other does not exist in the display device, and the abutted face is introduced for the sake of describing arrangement of liquid crystal molecules 128 more clearly. As illustrated in FIG. 2B and FIG. 5A, the charged type of the end, which is closer to the first alignment layer 126, of each of the liquid crystal molecules 128 in the first light deflection regions is opposite to the charged type of the end, which is closer to the first alignment layer 126, of each of the liquid crystal molecules 128 in the second light deflection regions. For example, as illustrated in FIG. 2B and FIG. 5A, one end, which is closer to the first alignment layer 126, of each of the liquid crystal molecules 128 in the first light deflection regions is negatively charged, and one end, which is closer to the first alignment layer 126, of each of the liquid crystal molecules 128 in the second light deflection regions is positively charged.

As illustrated in FIG. 2A, the first alignment layer 126 and the second alignment layer 127 may render the pretilt angle of liquid crystal molecules 128 being zero (in the case where the first sub-electrodes 141 and the second sub-electrodes 142 receive no driving voltage), that is, the long axes of liquid crystal molecules 128 are parallel to the second electrode layer 124. In this case, in order to make the liquid crystal molecules located in the one of the first light deflection regions 121 and the one of the second light deflection regions 122 that are adjacent to each other be arranged symmetrically with respect to the abutted face of the one of the first light deflection regions 121 and the one of the second light deflection regions 122 that are adjacent to each other, the liquid crystal molecules located in the first light deflection regions 121 and the liquid crystal molecules located in the second light deflection regions 122 may rotate by the same angle toward opposite directions. In this case, the absolute value of the difference between the first voltage (e.g., a positive voltage) and the opposite voltage is equal to the absolute value of the difference between the second voltage (e.g., a negative voltage) and the opposite voltage (e.g., 0V); and in the case of the opposite voltage being zero, the absolute value of the first voltage is equal to the absolute value of the second voltage, so that the drive device 135 can be simplified. Regarding the technology that the first alignment layer 126 and the second alignment layer 127 render the pretilt angle of liquid crystal molecules 128 being zero, reference to related techniques can be made, and details are omitted here.

As illustrated in FIG. 6, under the action of the liquid crystal control layer 120, the light emitted by the first pixels 111 and the second pixels 112 are incident into the user's left and right eyes, respectively, and therefore, the user's brain may produce stereoscopic vision based on a first image observed by the left eye and a second image observed by the right eye. Consequently, naked-eye 3D display can be realized by the display device 100 provided by an embodiment of the present disclosure.

For example, the first pixels 111 and the second pixels 112 respectively include at least one self-luminous component. As illustrated in FIG. 2A, in the case where the first pixels 111 and the second pixels 112 of the display array layer 110 are implemented with self-luminous components, the thickness of the display array layer 110 in the second direction D2 is less than the thickness of the liquid crystal control layer 120 in the second direction D2. Thereby, the thickness and weight of the display device 100 are reduced.

For example, the self-luminous components may be organic light emitting diodes (OLEDs), and in this case, the display array layer 110 may be implemented as an organic light emitting diode display panel. As compared with a display array layer 110 based on inorganic light emitting diodes, the thicknesses of the display array layer 110 and the display device 100 can be further reduced for the display panel based on organic light emitting diodes.

Each of the first pixels 111 and each of the second pixels 112 may include three organic light emitting diodes, respectively, and the above-mentioned three organic light emitting diodes, for example, emit red light, green light and blue light, respectively. In another embodiment, each of the first pixels 111 and each of the second pixels 112 may respectively include one organic light emitting diode, which emits, for example, any of red light, green light and blue light. In still another embodiment, the first pixels 111 and the second pixels 112 that are alternately arranged in the first direction D1 sequentially emit red light, green light and blue light in the horizontal direction.

As illustrated in FIG. 2A, the display device 100 may further include an insulating layer 131 disposed between the display array layer 110 and the first electrode layer 123, and the opposed surfaces of the insulation layer 131 are, for example, in direct contact with the display array layer 110 and the liquid crystal control layer 120, respectively. For example, the insulating layer 131 may be formed with an inorganic or organic material possessing a high transmittance (e.g., a transmittance greater than 95%) for the light in the visible wavelength range, and the insulating layer 131 may, for example, be formed with organic resin, silicon oxide (SiOx), silicon oxynitride (SiNxOy) or silicon nitride (SiNx), but embodiments of this disclosure are not limited to this cases.

As illustrated in FIG. 2A, the display device 100 further includes a first substrate 132, a second substrate 133 and a sealant 134. The first substrate 132 and the second substrate 133 interpose the display array layer 110 and the liquid crystal control layer stacked with each other between the first substrate 132 and the second substrate 133, and the sealant 134 is disposed in the peripheral area of the display device 100 and is used to combine together the first substrate 132 with the second substrate. The first substrate 132 and the second substrate 133 may be glass substrates, quartz substrates, plastic substrates (e.g. polyethylene terephthalate (PET) substrates) or substrates made of other suitable material. The sealant 134 may be formed from a resin (UV-cured resin or thermosetting resin), but embodiments of this disclosure are not limited to this cases. For example, the orthographic projection of the sealant 134 on the first substrate 132 and the orthographic projection of the display array layer 110 on the first substrate 132 are butted (for example, do not overlap and contact with each other).

For example, the first pixels 111 and the second pixels 112 may respectively include a first electrode, a luminous layer and a second electrode (not illustrated in the figure) sequentially disposed on the first substrate 132, and the first electrode and the second electrode, for example, may be an anode and a cathode, respectively. As illustrated in FIG. 2A, the insulating layer 131, the first electrode layer 123 and the first alignment layer 126 may be formed in sequence on the display array layer 110 (the second electrode of the display array layer 110), and the second electrode layer 124 and the second alignment layer 127 may be disposed in sequence on the second substrate 133. The liquid crystal layer 125 may be formed (for example, injected) between the first alignment layer 126 and the second alignment layer 127 after formation of the first alignment layer 126 and the second alignment layer 127, and after that, the sealant 134 may be disposed in the peripheral area of the display device 100 so as to combine together the first substrate 132 with the second substrate 133.

As illustrated in FIG. 2A, the thickness of the insulating layer 131 in the second direction D2 is less than the thicknesses of the first substrate 132 and the second substrate 133 in the second direction D2. By means of arranging the display array layer 110 between the liquid crystal control layer 120 and the first substrate 132, provision of an additional base substrate on either side of the display array layer 110 can be avoided, and only one insulating layer 131 is required to be arranged between the display array layer 110 and the liquid crystal control layer 120. Thus, the thickness of the display device 100 can be further reduced.

As illustrated in FIG. 2A, the thickness of the display array layer 110 in the second direction D2 is less than the thicknesses of the first substrate 132 and the second substrate 133 in the second direction D2, and thereby the thickness of the display device 100 can be further reduced. However, embodiments of this disclosure are not limited to this case. As illustrated in FIG. 2A, the thickness of the insulating layer 131 in the second direction D2 is less than the thickness of the display array layer 110 in the second direction D2, but embodiments of this disclosure are not limited to this case.

As illustrated in FIG. 2A, the display device 100 further includes a polarizer layer 137 disposed on the side of the second substrate 133 away from the liquid crystal control layer 120, and the polarizer layer 137 may, for example, be a circular polarizer. As a result, the problem of degradation of display quality caused by the ambient light reflected by the display device 100 can be alleviated.

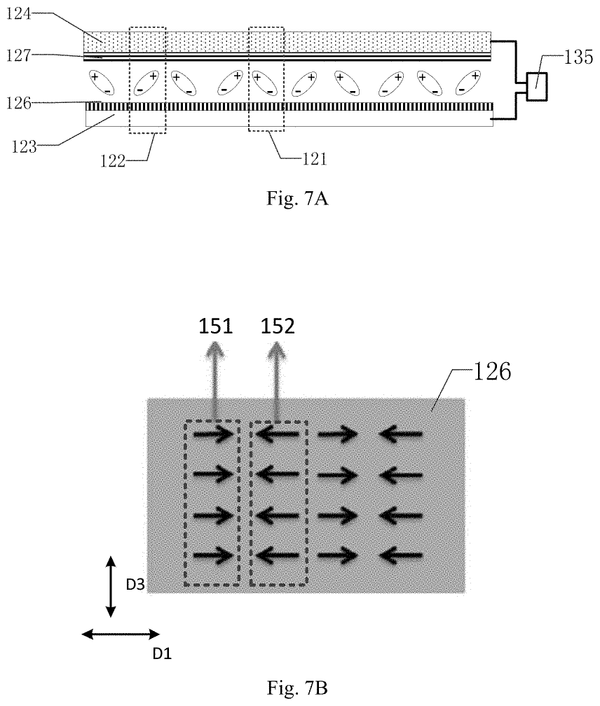

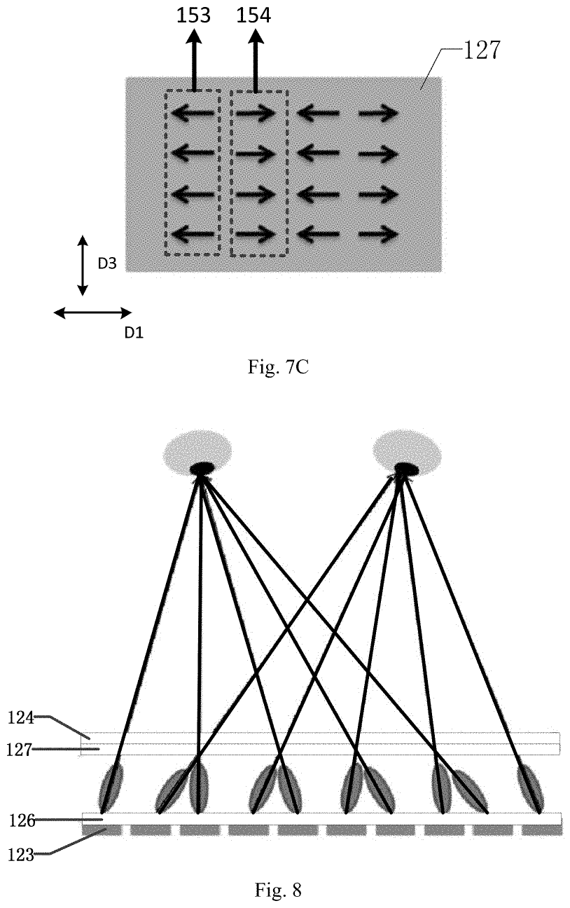

FIG. 7A is a schematic diagram illustrating another liquid crystal control layer 120 provided by at least one embodiment of the present disclosure. In this example, as illustrated in FIG. 7A, the display device 100 further includes a drive device 135 that is electrically connected to the first electrode layer 123 and the second electrode layer 124 and is configured to apply driving voltages to the first electrode layer 123 and the second electrode layer 124. Both the first electrode layer 123 and the second electrode layer 124 adopt plate-shape electrodes, and thereby the fabrication process of the first electrode layer 123 and the second electrode layer 124 can be simplified.

FIG. 7B and FIG. 7C are schematically plan views illustrating the first alignment layer 126 and the second alignment layer 127 as illustrated in FIG. 7A, respectively. As illustrated in FIG. 7B, the first alignment layer 126 includes first alignment units 151 respectively located in the first light deflection regions 121 and second alignment units 152 respectively located in the second light deflection regions 122; and the alignment direction of the first alignment units 151 is different from the alignment direction of the second alignment units 152. Both the alignment direction of the first alignment units 151 and the alignment direction of the second alignment units 152 are, for example, in the first direction D1 but opposite to each other, so as to form left alignment directions and right alignment directions that are alternately provided on the first alignment layer 126. In one embodiment, the left alignment directions of the first alignment layer 126 correspond to a left-eye view (image), and the right alignment directions of the first alignment layer 126 correspond to a right-eye view (image). However, embodiments of the present disclosure are not limited to this case.

As illustrated in FIG. 7C, the second alignment layer 127 includes third alignment units 153 respectively located in the first light deflection regions 121 and fourth alignment units 154 respectively located in the second light deflection regions 122; and the alignment direction of the third alignment units 153 is different from that of the fourth alignment units 154. The alignment direction of the third alignment units 153 and the alignment direction of the fourth alignment units 154 are, for example, in the first direction D1 and opposite, so as to form left alignment directions and right alignment directions that are alternately provided on the second alignment layer 127. In this case, the alignment direction of the third alignment units 153 is the same as the alignment direction of the second alignment units 152, and the alignment direction of the fourth alignment units 154 is the same as the alignment direction of the first alignment units 151. The alignment direction of the first alignment units 151 is opposite to that of the third alignment units 153, and the alignment direction of the second alignment units 152 is opposite to the alignment direction of the fourth alignment units 154.

For example, the first alignment units 151 and the third alignment units 153 are respectively opposite to each other in the second direction D2, and the width of the first alignment units 151 in the first direction D1 is equal to the width of the third alignment units 153 in the first direction D1. In this case, the orthographic projection of the first alignment units 151 on the second alignment layer 127 completely overlaps with the third alignment units 153. The second alignment units 152 and the fourth alignment units 154 are respectively opposite to each other in the second direction D2, and the width of the second alignment units 152 in the first direction D1 is equal to the width of the fourth alignment units 154 in the first direction D1. In this case, the orthographic projection of the second alignment units 152 on the second alignment layer 127 overlaps with the fourth alignment units 154 completely, so that the distribution of liquid crystal molecules in the liquid crystal layer can be better controlled. Consequently, display effect of the display device provided by an embodiment of the present disclosure can be promoted.

The first alignment layer 126 as illustrated in FIG. 7B and the second alignment layer 127 as illustrated in FIG. 7C may be formed using an optical orientation method, so as to enhance the fabrication accuracy of the first alignment units 151, the second alignment units 152, the third alignment units 153 and the fourth alignment units 154. However, embodiments of this disclosure are not limited to this case.

Under the action of the first alignment layer 126 as illustrated in FIG. 7B and the second alignment layer 127 as illustrated in FIG. 7C, the liquid crystal molecules 128 located in the first light deflection regions 121 and the liquid crystal molecules 128 located in the second light deflection regions 122 have pretilt angles as illustrated in FIG. 7A. For example, the first alignment layer 126 and the second alignment layer 127 may be configured to render the liquid crystal molecules 128 located in one of the first light deflection regions 121 and one of the second light deflection regions 122 that are adjacent to each other being symmetrically arranged with respect to an abutted face of the one of the first light deflection regions and the one of the second light deflection regions that are adjacent to each other. In this case, the absolute value of the pretilt angle (the angle between the pretilt angle and the plane parallel to the second electrode layer) of the liquid crystal molecules 128 located in the first light deflection regions 121 may be equal to the absolute value of the pretilt angle of the liquid crystal molecules 128 located in the second light deflection regions 122 (for example, each of them is equal to 2 to 4 degrees or 15 to 30 degrees). In other words, the absolute value of the angle (i.e., a first angle) between the liquid crystal molecules 128 located in the first light deflection regions 121 and the normal-line direction of the display device 100 (that is, the direction perpendicular to the display device 100) is equal to the absolute value of the angle (i.e. a second angle) between the liquid crystal molecules 128 located in the second light deflection regions 122 and the normal-line direction of the display device 100.

As illustrated in FIG. 7A, the first alignment layer 126 and the second alignment layer 127 render the charged type of one end, which is closer to the first alignment layer 126, of each of the liquid crystal molecules 128 in the first light deflection regions being the same as the charged type of one end, which is closer to the first alignment layer 126, of each of the liquid crystal molecules 128 in the second light deflection regions. Thus, in the case where each of the first electrode layer 123 and the second electrode layer 124 adopts a plate-shape electrode, the liquid crystal molecules 128 located in the first light deflection regions 121 and the liquid crystal molecules 128 located in the second light deflection regions 122 can be rotated in opposite directions as well. Therefore, the 3D display function can be realized by the display device provided by an embodiment of the present disclosure.

For example, in the case where the voltage applied onto the first electrode layer 123 is less than the voltage applied onto the second electrode layer 124, the liquid crystal molecules 128 located in the first light deflection regions 121 rotate clockwise (the first rotation direction), and the liquid crystal molecules 128 located in the second light deflection regions 122 rotate counterclockwise (the second rotation direction), that is, both the absolute value of the first angle and the absolute value of the second angle are decreased as compared to the liquid crystal molecules 128 in FIG. 7A. In this case, the decrement of the absolute value of the first angle and the absolute value of the second angle depends on the absolute value of the difference between the voltage applied onto the first electrode layer 123 and the voltage applied onto the second electrode layer 124.

For example, when the voltage applied onto the first electrode layer 123 is greater than the voltage applied onto the second electrode layer 124, the liquid crystal molecules 128 located in the first light deflection regions 121 rotate counterclockwise (the first rotation direction), the liquid crystal molecules 128 located in the second light deflection regions 122 rotate clockwise (the second rotation direction), that is, both the absolute value of the first angle and the absolute value of the second angle are increased as compared to the liquid crystal molecules 128 in FIG. 7A. In this case, the increment of the absolute value of the first angle and the absolute value of the second angle depends on the absolute value of the difference between the voltage applied onto the first electrode layer 123 and the voltage applied onto the second electrode layer 124.

For example, in the case where the first alignment layer 126 and the second alignment layer 127 are configured to render the absolute value of the pretilt angle of the liquid crystal molecules 128 located in the first light deflection regions 121 be equal to the absolute value of the pretilt angle of the liquid crystal molecules 128 located in the second light deflection regions 122, when no voltage is applied onto the first electrode layer 123 and the second electrode layer 124, the absolute value of the first angle is equal to the absolute value of the second angle. After a voltage is applied onto the first electrode layer 123 and the second electrode layer 124, the absolute value of the first angle is still equal to the absolute value of the second angle. Thereby, complexity of the drive device can be reduced, and 3D display effect of the display device 100 can be promoted. Therefore, the user's experience can be improved.

It is to be noted that, the absolute value of the pretilt angle of the liquid crystal molecules 128 can be set according to the actual application requirements. For example, when a user prefers to use 3D display function of the display device, the absolute value of the pretilt angle of liquid crystal molecules 128 may be set to be a larger value (e.g., being 30 degrees), so that 3D display function can be realized by the display device 100 with no voltage being applied onto the first electrode layer and the second electrode layer. When the user occasionally uses 2D display function of the display device, a voltage may be applied to the first electrode layer and the second electrode layer, so as to allow the long axes of liquid crystal molecules 128 to be, for example, parallel to the second electrode layer, and to allow the display device 100 to realize the 2D display function. In this case, power consumption of the display device 100 can be reduced.

For another example, when a user prefers to use 2D display function of the display device, the absolute value of the pretilt angle of liquid crystal molecules 128 may be set to be a smaller value (e.g., being 0.1 degrees). Thus, the long axes of liquid crystal molecules 128 may be rendered to be parallel to the second electrode layer 124 in the case where the first electrode layer and the second electrode layer receive relatively small voltages (for example, voltages received by the first electrode layer and the second electrode layer are 0.5V and 0V, respectively). In this case, 2D display function can be realized by the display device 100, and thereby power consumption of the display device can be reduced. When the user occasionally uses 3D display function of the display device, larger voltages may be applied to the first electrode layer and the second electrode layer (for example, the voltages received by the first electrode layer and the second electrode layer are 5V and 0V, respectively), so that the liquid crystal molecules 128 have a pre-set rotation angle (e. g., being 30 degrees). Thus, the light emitted from the first pixels 111 and the second pixels 112 can be incident into the user's left and right eyes, respectively. Therefore, the user's brain can produce stereoscopic vision based on a first image observed by the left eye and a second image observed by the right eye.

It is to be noted that, the liquid crystal control layer 120 as illustrated in FIG. 7A may also employ the first electrode layer 123 as illustrated in FIG. 3A or FIG. 3B. In this case, the drive device 135 is electrically connected to the first sub-electrodes 141 and the second sub-electrodes 142, and the drive device 135 is configured to apply the same voltage onto the first sub-electrodes 141 and the second sub-electrodes 142.

For example, an embodiment of the present disclosure further provides a display device 100, which further includes an eyeball tracking sensor and a control device as compared with the display device provided by the above-mentioned examples. The drive device 135 is configured to adjust the first voltage and the second voltage based on the output of the eye tracking sensor, so as to increase the viewing angle.

It is to be noted that, the viewing angle here is a viewing angle in the horizontal direction and may also be understood as a side-looking angle. By means of increasing the viewing angle in the horizontal direction, a user can observe an image outputted from the display device 100 without the need of standing directly in front of the display device 100. For example, in the case where the angle between the user and the normal direction of the display device 100 is increased to 60 degrees, the user still can see the image outputted by the display device 100, and the horizontal viewing angle of the display device 100 is greater than or equal to 120°.

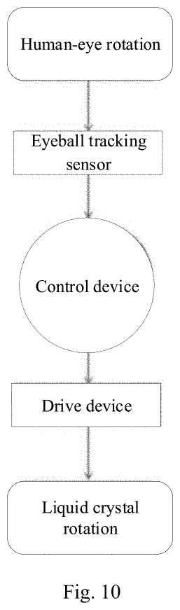

FIG. 10 is a schematic flowchart illustrating adjustment of formation position of first and second view points by the display device 100 that is provided by at least one embodiment of the present disclosure. As illustrated in FIG. 10, an eyeball tracking sensor may provide a sensing result of human eye rotation (eyeball rotation and/or eyeball position) or a sensing result of human eye movement that is acquired by the eyeball tracking sensor to a control device, and the control device provides a voltage regulation instruction to a drive device 135 based on the sensing result provided by the eye tracking sensor. Thereby, the voltage applied onto the first electrode layer 123 and/or the second electrode layer 124 can be altered. Thus, the rotation degree of liquid crystal molecules 128 can be changed, and then the formation position of the first and second view points can be changed.

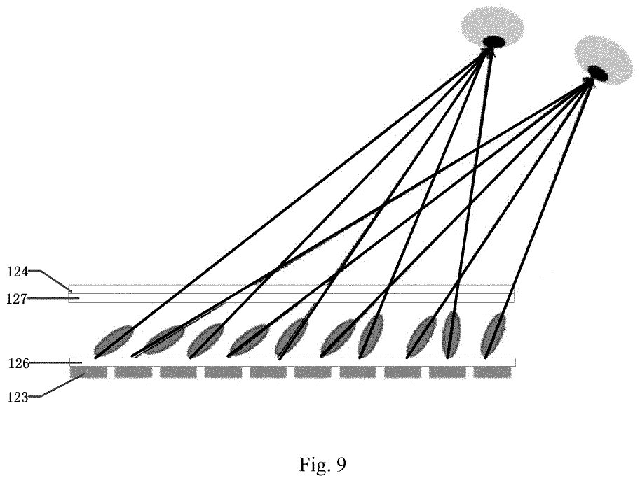

For example, FIG. 8 is a schematic diagram illustrating control of outgoing light of the display array layer 110 by the liquid crystal control layer 120 provided by an embodiment of the present disclosure, and in this case, the first and second view points may be formed directly in front of the display device 100. In this case, the user can see an image with 3D effect directly in front of the display device 100. For example, FIG. 9 is another schematic diagram illustrating control of outgoing light of the display array layer 110 by the liquid crystal control layer 120 provided by an embodiment of the present disclosure, and in this case, the first and second view points may be formed ahead of the display device 100 on the right. In this case, the user can see an image with 3D effect ahead of the display device 100 on the right.

For example, the eyeball tracking sensor may be arranged on the display device 100, and may include a CCD or CMOS camera, a light source, a lens, a capture card, etc.; here, the light collecting face of the CCD or CMOS camera faces the user's eyes. With the eyeball tracking sensor, for example, the user's real-time line-of-sight direction can be obtained by utilizing the following steps S110-S140, and thus the angle of rotation of eyes can be obtained.

Step S110: acquiring a human-face image. For example, in the case where the distance between the display device 100 (e.g. smart glasses) and the user is small, the eyeball tracking sensor can obtain at least part of the user's facial image directly. In the case where the distance between the display device 100 (e.g. a large-size television) and the user is large, the eyeball tracking sensor may extract the user's facial image from the image acquired by the eyeball tracking sensor.

Step S120: extracting an eye-region image. For example, one of the YCrCb color space human-eye extraction method, Hough transform fitting method, vertical and horizontal grayscale projection method and template matching method or a combination of the above-mentioned methods may be used to achieve human-eye detection and extract an eye-region image.

Step S130: extracting feature parameters on the eye-region image. The extracted parameters include the pupil's center and a corneal reflex brightspot (Purkinje image). For example, a binary image of the human-eye region may be obtained at first by using OSTU threshold segmentation method, and then, the corneal reflex brightspot is extracted by way of judging whether or not the extracted contour is a Purkinje image region with use of two kinds of features (i.e. roundness and gray scale), according to features of the Purkinje image. For example, the Hough transform fitting method, ellipse fitting algorithm based on the least square method, and circumference difference operator algorithm may be used to locate the pupil's center, and to extract parameters of the pupil's center.

Step S140: estimating line-of-sight based on the extracted feature parameters. For example, the direction of line-of-sight may be estimated by means of calculating a vector between the pupil's center and the corneal reflex brightspot (Purkinje image).

For example, the control device 50 may include a processor and a memory. The processor, for example, is a central processing unit (CPU) or a processing unit in other forms having data processing capability and/or instruction execution capability. For example, the processor may be implemented as a general-purpose processor (GPP) and may also be a microcontroller, a microprocessor, a digital signal processor (DSP), a special-purpose image processing chip, a field programmable logic array (FPLA), and the like. The memory, for example, may include a volatile memory and/or a non-volatile memory, for example, may include a read-only memory (ROM), a hard disk, a flash memory, and the like. Correspondingly, the memory may be implemented as one or more computer program products. The computer program products may include computer readable storage media in various forms. One or more computer program instructions may be stored in the computer readable storage medium. The processor may run the program instructions to realize the function of the control device in the embodiment of the present disclosure as described below and/or other desired functions. The memory may also store various other application programs and various data, for example, a sensing result outputted by the eyeball tracking sensor.

In at least one embodiment of the present disclosure, by using the method as illustrated in FIG. 10, the formation position of first and second view points can be changed according to the eyeball rotation and/or eyeball position, and then the viewing angle of the display device 100 can be enhanced. In addition, crosstalk can also be reduced by changing the formation position of the first and second view points with the method illustrated in FIG. 10. The reason is that, in such a case, the light that are provided by the display array layer 110 and correspond to a left-eye image can be avoided from entering the user's right eye, and the light that are provided by the display array layer 110 and correspond to a right-eye image can be avoided from entering the user's left eye.

The display device may be any product or component with display function such as a mobile phone, a tablet computer, a television, a display, a notebook computer, a digital photo frame, a navigator, and so on.

It should be noted that other components (for example, a thin-film transistor, a control device, an image data encoding/decoding device, a clock circuit and so on) of the display device may adopt conventional components, this should be understood by those skilled m the art, no further descriptions will be given herein and it should not be construed as a limitation on the embodiments of the present disclosure.

Although detailed description has been given above to the present disclosure with general description and embodiments, it shall be apparent to those skilled in the art that some modifications or improvements may be made on the basis of the embodiments of the present disclosure. Therefore, all the modifications or improvements made without departing from the spirit of the present disclosure shall all fall within the scope of protection of the present disclosure.

What are described above is related to the illustrative embodiments of the disclosure only and not limitative to the scope of the disclosure; the scopes of the disclosure are defined by the accompanying claims.

What is claimed is:

1. A display device, comprising a display array layer and a liquid crystal control layer superimposed on a display side of the display array layer,
wherein the liquid crystal control layer comprises a first electrode layer, a liquid crystal layer and a second electrode layer;
the display array layer comprises first pixels and second pixels which are alternately arranged in a first direction;
the first electrode layer and the second electrode layer are configured to receive driving voltages, so as to allow liquid crystal molecules in the liquid crystal layer to rotate to form first light deflection regions and second light deflection regions that are alternately arranged in the first direction;
the first light deflection regions respectively correspond to the first pixels and the second light deflection regions respectively correspond to the second pixels; and
light that is emitted from the first pixels and enters the first light deflection regions is deflected to form a first view point, and light that is emitted from the second pixels and enters the second light deflection regions is deflected to form a second view point.

2. The display device according to claim 1, wherein the liquid crystal molecules are ionic liquid crystals.

3. The display device according to claim 1, wherein widths of the first light deflection regions in the first direction are respectively equal to widths of corresponding first pixels in the first direction; and
widths of the second light deflection regions in the first direction are respectively equal to widths of corresponding second pixels in the first direction.

4. The display device according to claim 1, wherein the first electrode layer comprises first sub-electrodes respectively located in the first light deflection regions and second sub-electrodes respectively located in the second light deflection regions.

5. The display device according to claim 4, wherein the liquid crystal control layer further comprises a first alignment layer and a second alignment layer;
the first alignment layer is disposed on a side, which is closer to the liquid crystal layer, of the first electrode layer, the second alignment layer is disposed on a side, which is closer to the liquid crystal layer, of the second electrode layer; and
the first alignment layer and the second alignment layer are configured to allow liquid crystal molecules located in the first light deflection regions to be capable of rotating toward a first rotation direction and to allow liquid crystal molecules located in the second light deflection regions to be capable of rotating toward a second rotation direction that is opposite to the first rotation direction.

6. The display device according to claim 5, wherein the first alignment layer and the second alignment layer are further configured to allow liquid crystal molecules located in one of the first light deflection regions and one of the second light deflection regions that are adjacent to each other to be arranged symmetrically with respect to an abutted face of the one of first light deflection regions and the one of second light deflection regions that are adjacent to each other.

7. The display device according to claim 5, wherein an alignment direction of the first alignment layer corresponding to the first light deflection regions is same as an alignment direction of the first alignment layer corresponding to the second light deflection regions;
an alignment direction of the second alignment layer corresponding to the first light deflection regions is same as an alignment direction of the second alignment layer corresponding to the second light deflection regions; and
the alignment direction of the first alignment layer corresponding to the first light deflection regions is opposite to the alignment direction of the second alignment layer corresponding to the first light deflection regions.

8. The display device according to claim 7, wherein the display device further comprises a drive device that is electrically connected to the first sub-electrodes and the second sub-electrodes and is configured to apply the driving voltages to the first sub-electrodes and the second sub-electrodes;
the drive device is configured to apply a first voltage to the first sub-electrodes, apply a second voltage to the second sub-electrodes, and to apply an opposite voltage to the second electrode layer;
the first voltage, the second voltage and the opposite voltage are functioning as the driving voltages; and
the first voltage is greater than the opposite voltage, and the second voltage is smaller than the opposite voltage.

9. The display device according to claim 8, wherein an absolute value of a difference between the first voltage and the opposite voltage is equal to an absolute value of a difference between the second voltage and the opposite voltage.

10. The display device according to claim 5, wherein the first alignment layer comprises first alignment units respectively located in corresponding first light deflection regions and second alignment units respectively located in corresponding second light deflection regions, wherein an alignment direction of the first alignment units and an alignment direction of the second alignment units are opposite; and
the second alignment layer comprises third alignment units respectively positioned in corresponding first light deflection regions and fourth alignment units respectively positioned in corresponding second light deflection regions, wherein an alignment direction of the third alignment units and an alignment direction of the fourth alignment units are opposite.

11. The display device according to claim 10, wherein the alignment direction of the third alignment units is same as the alignment direction of the second alignment units; and
the alignment direction of the fourth alignment units is same as the alignment direction of the first alignment units.

12. The display device according to claim 11, wherein the display device further comprises a drive device that is electrically connected to the first sub-electrodes and the second sub-electrodes and is configured to apply the driving voltages to the first sub-electrodes and the second sub-electrodes; and
the drive device is configured to apply same one voltage to the first sub-electrodes and the second sub-electrodes.

13. The display device according to claim 1, further comprising a first substrate, a second substrate, an insulating layer and a sealant,
wherein the first substrate and the second substrate are configured to interpose the display array layer and the liquid crystal control layer that are stacked with each other between the first substrate and the second substrate;
the insulating layer is disposed between the display array layer and the first electrode layer; and
the sealant is disposed in a peripheral area of the display device and is used to combine together the first substrate with the second substrate.

14. The display device according to claim 13, wherein the first pixel and the second pixel respectively comprise a self-luminous component.

15. The display device according to claim 1, further comprising an eyeball tracking sensor,
wherein the display device is configured to adjust the driving voltages applied to the first electrode layer and the second electrode layer based on an output of the eyeball tracking sensor.

16. The display device according to claim 3, wherein the first electrode layer comprises first sub-electrodes respectively located in the first light deflection regions and second sub-electrodes respectively located in the second light deflection regions.

17. The display device according to claim 16, wherein the liquid crystal control layer further comprises a first alignment layer and a second alignment layer;
the first alignment layer is arranged on a side, which is closer to the liquid crystal layer, of the first electrode layer, and the second alignment layer is arranged on a side, which is closer to the liquid crystal layer, of the second electrode layer; and
the first alignment layer and the second alignment layer are configured to allow liquid crystal molecules located in the first light deflection regions to be capable of rotating toward a first rotation direction and to allow liquid crystal molecules located in the second light deflection regions to be capable of rotating toward a second rotation direction that is opposite to the first rotation direction.

18. The display device according to claim 17, wherein the first alignment layer and the second alignment layer are further configured to allow the liquid crystal molecules located in one of the first light deflection regions and one of the second light deflection regions that are adjacent to each other to be arranged symmetrically with respect to an abutted face of the one of first light deflection regions and the one of second light deflection regions that are adjacent to each other.

19. The display device according to claim 18, wherein an alignment direction of the first alignment layer corresponding to the first light deflection regions is same as an alignment direction of the first alignment layer corresponding to the second light deflection regions;
an alignment direction of the second alignment layer corresponding to the first light deflection regions is same as an alignment direction of the second alignment layer corresponding to the second light deflection regions; and
the alignment direction of the first alignment layer corresponding to the first light deflection regions is opposite to the alignment direction of the second alignment layer corresponding to the first light deflection regions.

20. The display device according to claim 18, wherein the first alignment layer comprises first alignment units respectively located in corresponding first light deflection regions and second alignment units respectively located in corresponding second light deflection regions, wherein an alignment direction of the first alignment units and an alignment direction of the second alignment units are opposite; and
the second alignment layer comprises third alignment units respectively positioned in corresponding first light deflection regions and fourth alignment units respectively positioned in corresponding second light deflection regions, wherein an alignment direction of the third alignment units and an alignment direction of the fourth alignment units are opposite.
